(19) United States
(12) Patent Application Publication
(10) Pub. No.: US 2024/0242068 A1
(43) Pub. Date: Jul. 18, 2024

(54) SYSTEM, METHOD, DEVICE, AND PROGRAM FOR ENHANCED GRAPH-BASED NODE CLASSIFICATION

(71) Applicant: RAKUTEN SYMPHONY SINGAPORE PTE. LTD., Singapore (SG)

(72) Inventors: Xiaohui RONG, Tokyo (JP); Allan Kiplangat CHEPKOY, Tokyo (JP); Yulong WANG, Tokyo (JP)

(73) Assignee: RAKUTEN SYMPHONY SINGAPORE PTE. LTD., Singapore (SG)

(21) Appl. No.: 18/010,163

(22) PCT Filed: Sep. 30, 2022
(86) PCT No.: PCT/US2022/045374

§ 371 Date: Dec. 13, 2022

(51) Int. Cl. G06N 3/08

(52) U.S. Cl. CPC G06N 3/08

(57) ABSTRACT

System, method, device, and program for graph embedding based on graph data and non-graph data are provided. The method and processes may be executed by at least one processor and may include receiving graph data associated with one or more users, and receiving classification data associated with the one or more users, wherein the classification data comprises non-graph data associated with the one or more users. The method and processed may further include generating an accuracy parameter based on the classification data associated with the one or more users, wherein the accuracy parameter indicates an accuracy of neural network-based classification results based on the classification data; and generating numerical node representation using a neural network-based graph embedding model associated with the one or more users based on the graph data, the classification data, and the accuracy parameter.

### FIELD

The present disclosure relates graph-based system and methods. More specifically, the present disclosure relates to enhanced graph embedding methods based on graph and non-graph information.

### BACKGROUND

Graph-based methods and systems are widely used for classification tasks, e.g., user classification, vocabulary classification based on its location, etc. In such graph-based classification systems, for example, a user classification system, a user network forms a graph, a node may represent each associated user, and the relationship between the users may be represented by links between the nodes. User category or community can be detected based on the graph topology, with users belonging to the same community/category having similar behavior. In the context of natural language processing, words may be represented as nodes in the graph, and the connection between words may be the links. Words belonging to the same community/category may be used frequently or may have similar meanings or have a commonality in what the words represent.

The location of each of node in the graph may be represented based on one or more numerical representations using graph embedding techniques. The numerical representations are graphical representations of the nodes, with similar nodes being located near each other in graph topology. These numerical node representations may then be used as for one or more classification model(s) that classify and/or label the node (e.g., user category or grouping words having similar meanings). Thus, related graph-based embedding methods and systems merely focus on graph data when generating numerical node representations.

The utilization of graph data and non-graph data in classification tasks are essentially independent processes, that results in inaccurate classification and an inefficient use of computing and data resources. Therefore, enhanced graph embedding methods and systems are needed that can more efficiently utilize both graph data and non-graph data efficiently and effectively to improve the accuracy of classification tasks and/or models.

### SUMMARY

According to embodiments, a method for graph embedding based on graph data and non-graph data may be provided. The method may be executed by at least one processor and may include receiving graph data associated with one or more users, and receiving classification data associated with the one or more users, wherein the classification data comprises non-graph data associated with the one or more users; generating an accuracy parameter based on the classification data associated with the one or more users, wherein the accuracy parameter indicates an accuracy of neural network-based classification results based on the classification data; and generating numerical node representation using a neural network-based graph embedding model associated with the one or more users based on the graph data, the classification data, and the accuracy parameter.

According to an aspect, the method may further include inputting the numerical node representation and a concatenation of node attributes into a neural network-based classifier, wherein the neural network-based classifier is trained using the classification data associated with the one or more users; and generating classification results based on the neural network-based classifier.

According to an aspect, the neural network-based graph embedding model may be based on a combination of a first objective function based on user relationships based on the graph data and a second objective function based on user classification labels based on the classification data.

According to an aspect, generating the numerical node representation using the neural network-based graph embedding model may include minimizing the combination of the first objective function and the second objective function.

According to an aspect, one or more second layers of the neural network-based graph embedding model may process the combination of the first function and the second function. In some embodiments, one or more first layers of the neural network-based graph embedding model may process one or more user attributes based on the non-graph data.

According to an aspect, the numerical node representation of a first user among the one or more users and a second user among the one or more users may have a cosine similarity higher than a threshold, and wherein the first user and the second user may have a same classification label based on the classification data.

According to an aspect, the numerical node representation of a first user among the one or more users and a second user among the one or more users may have a cosine similarity higher than a threshold, and wherein the first user and the second user may be in a same neighborhood based on the graph data.

According to an aspect, the accuracy parameter may be based on a concatenation of one or more user attributes, wherein the one or more user attributes are based on the non-graph data.

According to embodiments, an apparatus for graph embedding based on graph data and non-graph data may be provided. The apparatus may include at least one memory configured to store program code; and at least one processor configured to read the program code and operate as instructed by the program code. The program code may include first receiving code configured to cause the at least one processor to receive graph data associated with one or more users; second receiving code configured to cause the at least one processor to receive classification data associated with the one or more users, wherein the classification data comprises non-graph data associated with the one or more users; first generating code configured to cause the at least one processor to generate an accuracy parameter based on the classification data associated with the one or more users, wherein the accuracy parameter indicates an accuracy of neural network-based classification results based on the classification data; and second generating code configured to cause the at least one processor to generate numerical node representation using a neural network-based graph embedding model associated with the one or more users based on the graph data, the classification data, and the accuracy parameter.

According to embodiments, a non-transitory computer-readable medium storing instructions for graph embedding based on graph data and non-graph data may be provided. The instructions comprising: one or more instructions that, when executed by one or more processors, may cause the one or more processors to receive graph data associated with one or more users; receive classification data associated with the one or more users, wherein the classification data comprises non-graph data associated with the one or more users; generate an accuracy parameter based on the classification data associated with the one or more users, wherein the accuracy parameter indicates an accuracy of neural network-based classification results based on the classification data; and generate numerical node representation using a neural network-based graph embedding model associated with the one or more users based on the graph data, the classification data, and the accuracy parameter.

### BRIEF DESCRIPTION OF THE DRAWINGS

Features, advantages, and significance of exemplary embodiments of the disclosure will be described below with reference to the accompanying drawings, in which like signs denote like elements.

FIG. 1 is an example diagrammatic illustration of graph embedding in related art.

FIG. 2 is an example diagrammatic illustration of enhanced graph embedding, according to embodiments of the present disclosure.

FIG. 3 is an example flowchart illustrating an example process for enhanced graph embedding, according to embodiments of the present disclosure.

FIG. 4 is an example diagrammatic illustration of a network architecture for generating enhanced graph embeddings, according to embodiments of the present disclosure.

FIG. 5 is an example diagrammatic illustration of a component of the network architecture of FIG. 4, according to embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

As is traditional in the field, embodiments may be described and illustrated in terms of blocks which carry out a described function or functions. These blocks, which may be referred to herein as units or modules or the like, may be physically implemented by analog or digital circuits such as logic gates, integrated circuits, microprocessors, microcontrollers, memory circuits, passive electronic components, active electronic components, optical components, hardwired circuits, or the like, and may be driven by firmware and software. The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise.

As stated above, related art includes graph embedding methods and systems that have independent processes that utilize graph data and non-graph data. This independence may result in a dissonance between the numerical node representation of the data and the classification labels generated by the classification tasks.

Generating numerical representation based only on graph data comprises selecting appropriate information from graph data, generating numerical representations based on the selected information, and embedding one or more nodes to the generated numerical representations. As an example, in the context of user data (e.g., user call data), generating numerical representations associated to each user comprises selecting appropriate user information (e.g., information which best reflect the relationship between the users) from user graph data (i.e., data which shows the direct relationship between users) (also referred to as “graph data,” “graphical data,” “graphical user data,” etc.). The selected information may be used to generate numerical representations, and embedding one or more nodes (each of which represents 1 respective user) to the generated numerical representations.

According to an embodiment, user graph data may include user information, such as user call data, billing transaction records, and interactions on social media, etc. The system can select any of the appropriate data for further processing.

Throughout the disclosure, user call records or user information may be used as a non-limiting example of embodiments of related art and the present disclosure. User call data may be represented as shown in Table 1.

TABLE 1
User Call Data (Graph Data)

| USER_ID | Call Record |
|---|---|
| 0 | Called user 1 & user 2 |
| 1 | Called user 0 & user 2 |
| 2 | Called user 0, user 1, & user 3 |
| 3 | Called user 2 |

Based on the user call record, numerical node representations may be generated using appropriate graph embedding methods and systems. Table 2 provides an examples of numerical node representations based on user call data.

TABLE 2
Numerical Node Representations Based on Call Data (Graph Data)

| 0 | 1 | 2 | USER_ID |
|---|---|---|---|
| −0.18581957 | −0.21377566 | 0.21559885 | 0 |
| −0.18768942 | −0.21523947 | 0.21934521 | 1 |
| −0.18722303 | −0.21444497 | 0.21966717 | 2 |
| −0.17539057 | −0.21019386 | 0.19833624 | 3 |

As shown in Table 2, the numerical representations may be numerical values representing the relationship between the users (e.g., compared to user 3, user 0 has numerical representations closer (e.g., higher cosine similarity) to user 1, implying that user 0 may have a closer relationship with user 1). In some embodiments, the numerical representations may show the position of each user in a form of multi-dimensional vector in a graph, and the relationship between the users may be also reflected in the graph (e.g., users having closer numerical representation will be located closer to each other.) In the example illustrated in Table 2, 3-dimensional numerical representations may be generated for each user, wherein columns “0”, “1”, “2” may represent the numerical values for the first dimension, second dimension, and third dimension, respectively. The relationship between different users (i.e., nodes) may be determined based on the associated numerical representations. Table 3 illustrates an example of relationship between different users.

TABLE 3
Connections Based on Call Data (Graph Data)

| | Numerical | |
|---|---|---|
| USER_ID | Representations | Connected node |
| 0 | X, Y, Z | 1, 2 |
| 1 | W, X, Y, | 0, 2 |
| 2 | V, W, X | 0, 1, 3 |
| 3 | T, U, V | 2 |

In view of the above, by generating numerical representations for the users/nodes based on the user graph data, the system may group nodes 0, 1, and 2 into the same group, since these nodes are neighboring to each other. Node 3, on the other hand, may be determined as falling under a different group since it is not directly associated to nodes 0 and 1. Accordingly, the system may assume that users 0, 1, and 2 have behavior similar to each other while user 3 may have behavior different.

Nevertheless, in reality, node 3 may fall under the same group of nodes 0 and/or 1, even if it is not directly connected to nodes 0 and/or 1. As an example, user 3 (user with user_id 3) may be located at the same geographical location as user 0 or user1, or user 3 may fall under another group that the one it is located in. Therefore, graph embedding process in related art, although able to determine the potential group of users by determining the direct relationships among the users, it is unable to accurately identify and classify all potential users alone which are not directly associated/neighboring to each other.

On the other hand, graph-based classification tasks that utilize non-graphical data may comprise determining one or more classification results (including, in some embodiments, classification labels) for a node based on user non-graph data (also referred to as “non-graph data,” “non-graphical data,” “non-graphical user data,” etc.) and the numerical representations associated with each node. As an example, in the context of user data discussed above, graph-based classification tasks that utilize non-graph data may comprise determining a user's category based on user non-graph data and the numerical representations associated with each user.

According to an embodiment, user category may include classifying users as active user, non-active user, etc. Non-graph user data may include data which shows the detailed information of each user but does not show the direct relationship with other users, e.g., single user view data indicating user address, income, age, tenure, occupation, gender, years of the service plan enrolled, and any other parameters that are suitable for categorizing the user. Non-graph data may also include one or more user attributes by category. As an example, the non-graph user data may comprise a user age group, in which age 0-18 years old may belong to Category A, 19-29 may belong to Category B, etc.

Classification based on only on non-graph data alone, although may determine the category of users (i.e., node), is not sufficient in reflecting the relationship and potential impact among the users, e.g., if user 1 has closer relationship with user 2, etc.

In addition to the data used, the formulas and objective functions used is another difference. Simple combination of those formulas and objective functions does not produce accurate results. Therefore, systems and methods that can compute numerical node representations and therefore classification results based on both graph data and non-graph data are needed. To do so, a new formula, which is compatible for computing numerical node representations based on both graph data and non-graph data, is needed.

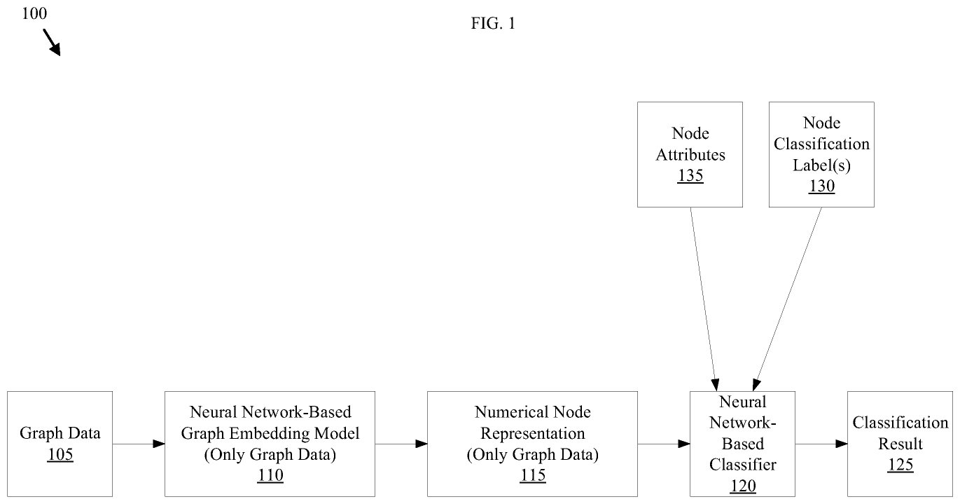

FIG. 1 is an example process 100 for classification using graph embedding in related art.

As shown in process 100, graph data 105 (e.g., user graph data) is received and then transmitted to a neural network-based graph embedding model 110. Graph data 105 to be transmitted may be selected based on one or more criteria associated with the classification task (e.g., classifying users based on billing transaction data and/or call record data, both of which are in different domains, or classifying users based on activity, etc.). The neural network-based graph embedding model 110 may use any suitable graph embedding method (e.g., DeepWalk-based models, node2vec-based models, etc.) to generate numerical node representations 115 using the graph data. The numerical node representations 115 may then be used as input to a neural network-based classifier 120 associated with the classification task. In addition to the numerical node representations 115, non-graph data associated with the users may be input into the neural network-based classifier 120. The non-graph data may include node attributes 135 (e.g., user attributes) and node classification labels 130 (e.g., age-based classification, geography-based classification, etc.). The neural network-based classifier 120 may generate node classification results 125 classifying the node based on the classification task.

As an example, process 100 may be used for user classification based on user connections with other users and user attributes. However, as shown in process 100, the neural network-based graph embedding model 110 may simply use graph data associated with the users comprising user connectivity information to generate numerical node representations. These numerical node representations, based only on graph data may not accurately reflect user relationships because non-graph data such as user characteristics is not accounted for in the numerical node representations. This leads to less accurate and often incomplete numerical node representations leading to incorrect classification. Furthermore, since non-graph data is considered during the classification by the neural network-based classifier 120, not accounting for non-graph data, that is being processed anyway, is an inefficient use of data resources.

Therefore, systems and methods that can compute numerical node representations based on both graph data and non-graph data are needed. The present disclosure describes methods and systems which are compatible for computing numerical node representations based on both graph data and non-graph data.

Embodiments of the present disclosure are directed to a combination of functions that may be used to computing numerical node representations based on both graph data and non-graph data. More particularly, an accuracy parameter representing the accuracy of the classification result of the nodes (which is generated based on non-graph data) is computed, and the accuracy parameter may be used together with the graph data to compute the numerical representations of a node.

The graph embedding objective function that represents the node (e.g., user or word) relationships based on the graph data may be defined as follows:

$$Minimize {\sum }_{i = 1}^{V} ( - ln ( {\prod }_{{v}_{n} ∈ {N}_{s} ( {v}_{i} )} \frac{{e}^{f ( {v}_{n} ) \cdot f ( {v}_{i} )}}{{\sum }_{j = 1}^{V} {e}^{f ( {v}_{j} ) \cdot f ( {v}_{i} )}} ) ) \qquad Eqn . ( 1 )$$

In some embodiments, graph embedding objective function that represents the node relationships based on the graph data may be implement using a skip-gram based algorithm. In an embodiment of the present disclosure, an objective function representing the accuracy of the classification result is computed based on a suitable loss function, e.g., cross entropy loss algorithm. The objective function may be defined as follows:

$$Minimize {\sum }_{i = 1}^{V} ( - {\sum }_{c = 1}^{C} {y}_{ci} ln ) \qquad Eqn . ( 2 )$$

In which, [symbol] may be the classification result of node vᵢ based on a concatenation of node attributes and numerical node representations. The classification result of the node vᵢ may be represented as follows:

$$= g ( f ( {v}_{i} ) + h ( {\sum }_{k = 1}^{K} att {\_v}_{ik} ) ) \qquad Eqn . ( 3 )$$

According to an embodiment, the calculated object function may be combined with the graph embedding object function. The combined objective function may be represented as follows:

$$Minimize {\sum }_{i = 1}^{V} ( - ln ( {\prod }_{{v}_{n} ∈ {N}_{s} ( {v}_{i} )} \frac{{e}^{f ( {v}_{n} ) \cdot f ( {v}_{i} )}}{{\sum }_{j = 1}^{V} {e}^{f ( {v}_{j} ) \cdot f ( {v}_{i} )}} ) + α ( - {\sum }_{c = 1}^{C} {y}_{ci} ln ) ) \qquad Eqn . ( 4 )$$

According to embodiments, V may indicate the number of nodes (e.g., users, words, etc.); C may indicate the number of categories in the classification results and/or labels; K may indicate the number of node attributes (e.g., user attributes, word attributes, etc.); ƒ(vᵢ) may be the numerical representation of a node vᵢ; Nₛ(vᵢ) may be a set of nodes neighboring node vᵢ; att_vᵢ may be the node attributes of node vᵢ, y_{ci} is the classification label of node vᵢ, and a may indicate a balancing parameter ranging from 0 to 1 to balance the combination of the functions.

According to embodiments, the enhanced graph embedding methods and systems disclosed herein are based on a combination of at least two objectives and/or objective functions—nodes belonging to the same category must have similar numerical representations (reflecting non-graph data such as characteristics), and nodes having close connections in a graph must have similar numerical representation and/or must be classified as belonging to the same category (reflecting graph data such as node connectivity).

According to an embodiment of the present disclosure, node attributes of node vᵢ based on the non-graph data may be processed by one or more layers of fully connected neural network, and may be represented as a mapping function h(att_vᵢ). In some embodiments, node graph data of node vᵢ may be processed by one or more layers of the fully connected neural network, and may be represented as a mapping function ƒ(vᵢ). In some embodiments, the concatenation of h(att_vᵢ) and ƒ(vᵢ) may be processed by one or more layers of the fully connected neural network, and may be represented as a mapping function g(ƒ(vᵢ)+h(att_vᵢ)), as the user classification result.

According to an aspect of the disclosure, the numerical representation of the nodes may be based on both user graph data and user non-graph data and may be generated according to embodiments while the node classification result may also simultaneously be generated using any suitable methods and/or neural network-based models.

As stated above, the above processes and formulas are merely exemplary and may be used for classification tasks other than user classification, such as classifying the vocabulary in text. As an example, for a sentence “User A likes to sing”, it may be presented in for form of: [User A, likes, to, sing]. Each word may be assigned to a node, and the processes and formulas described herein may be performed in a as disclosed to determine the relationship between the words and then further classify these words.

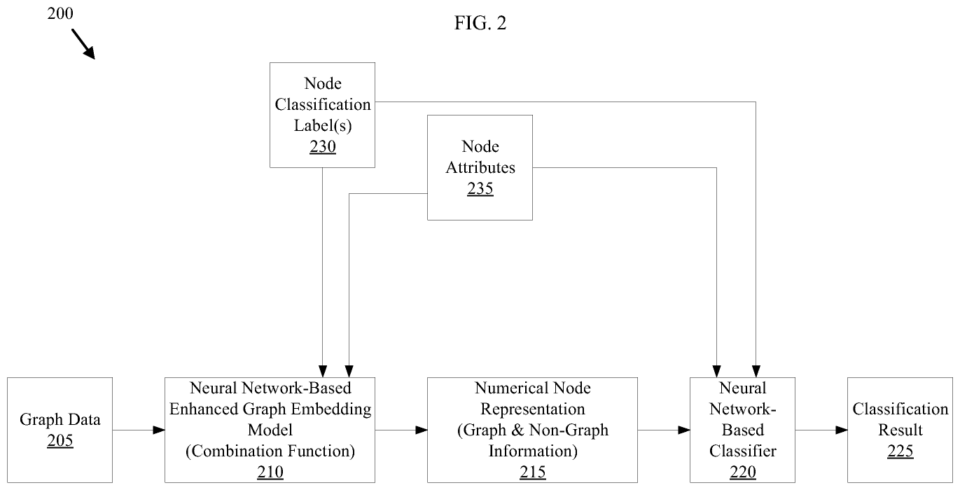

FIG. 2 is an example process 200 for classification using graph embedding based on a combination of graph and non-graph data according to embodiments of the present disclosure.

As shown in process 200, graph data 205 (e.g., user graph data) (in some embodiments graph data 105 may also be used) is received and then transmitted to a neural network-based enhanced graph embedding model 210. Graph data 205 to be transmitted may be selected based on one or more criteria associated with the classification task (e.g., classifying users based on activity, or classifying users based on billing transaction data and/or call record data, both of which are in different domains, etc.). In addition to the graph data 205, the neural network-based enhanced graph embedding model 210 also receives node attributes 235 and node classification labels 230. The neural network-based enhanced graph embedding model 210 may also generate an accuracy parameter reflecting the accuracy of the node classification result and/or labels 230. The accuracy parameter may be based on a concatenation of one or more node attributes 235, wherein the one or more node attributes 235 may be based on the non-graph data.

The neural network-based-graph embedding model 210 may use a function implementing Eqn (4) or any suitable graph embedding method (e.g., DeepWalk-based models, node2vec-based models, etc.) to generate numerical node representations 215 using the graph data 205, accuracy parameter, node attributes 235, and node classification labels 230. The numerical node representations 215 may then be used as input to a neural network-based classifier 220 associated with the classification task. In addition to the numerical node representations 215, non-graph data associated with the users may be input into the neural network-based classifier 220. The non-graph data may include node attributes 235 (e.g., user attributes) and node classification labels 230 (e.g., age-based classification, geography-based classification, etc.). The neural network-based classifier 220 may generate node classification results 225 classifying the node based on the classification task.

Thus, embodiments of the present disclosure provide methods and systems to generate numerical node representations based on a combination of both graph data and non-graph data.

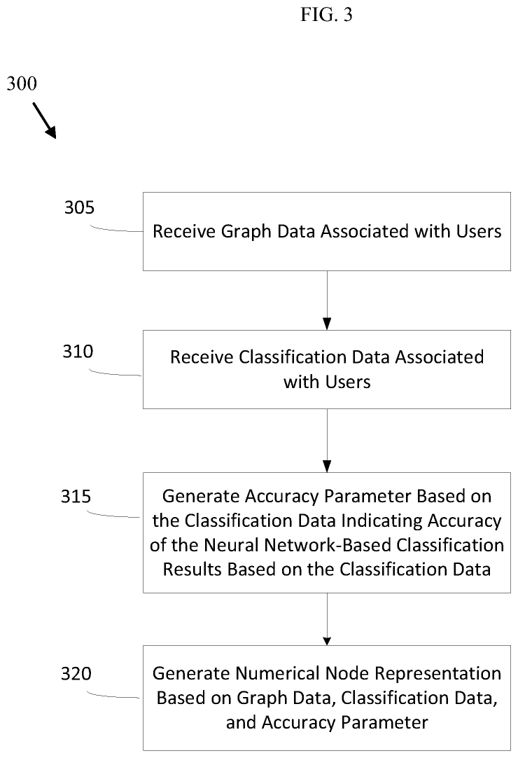

FIG. 3 is an example flowchart illustrating an example process 300 for generating numerical node representations associated with one or more users using enhanced graph embedding based on graph data and non-graph data, according to embodiments of the present disclosure.

At operation 305, graph data associated with one or more users may be received. Graph data associated with the one or more users may include information reflecting the relationship between the one or more users or information which shows the direct relationship between the one or more users. As an example, graph data may include call records, billing transaction records, social media interactions, etc. In some embodiments, graph data associated with the one or more users may be received using user terminals or may be transmitted over a network from a data management system or data repository.

At operation 310, classification data associated with the one or more users, wherein the classification data comprises non-graph data associated with the one or more users may be received. In some embodiments, non-graph data associated with the one or more users may include user attributes and/or classification labels associated with user attributes. Non-graph data associated with the one or more users may include information about each user that does not show the direct relationship with other users. As an example, user attributes may include information such as: single user view data indicating user address, income, age, tenure, occupation, gender, years of the service plan enrolled, and one or more categories associated with a user.

In some embodiments, the data management system may determine the type of the data provided by and to the user terminals, and may also store the data into a respective repositories. In some embodiments, data of similar types may be added to a same dataset in the data management system. As an example, graph data associated with users may be added to a first dataset and non-graph data associated with the users may be added to a second dataset or the same dataset. In some embodiments, after determining the type of the data and labelling the data, the data management system may provide the data to the classification models in real-time/near real-time. Data repositories may store graph data associated with users (e.g., call detail records, financial transaction records, etc.), non-graph data associated with the users (e.g., single customer view data, etc.), the generated numerical node representations, and the classification results.

At operation 315, an accuracy parameter based on the classification data associated with the one or more users may be generated. In some embodiments, the accuracy parameter may indicate an accuracy of classification results and/or labels associated with the classification data. The accuracy parameter may be based on a concatenation of one or more user attributes, wherein the one or more user attributes are based on the non-graph data. As an example, in some embodiments, the neural network-based enhanced graph embedding model 210 may generate an accuracy parameter associated with the classification labels associated with the classification data.

At operation 320, numerical node representation may be generated using a neural network-based graph embedding model associated with the one or more users based on the graph data, the classification data, and the accuracy parameter. As an example, the numerical node representation 215 may be generated using the neural network-based enhanced graph embedding model 210 based on the accuracy parameter, the graph data 205, and the non-graph data including the node attributes 235 and node classification labels 230 associated with the one or more users.

According to an aspect of the disclosure, the neural network-based graph embedding model may be based on a combination of a first function based on user relationships based on the graph data and a second function based on user classification labels based on the classification data. The generation of the numerical node representation using the neural network-based graph embedding model may include minimizing the combination of the first function and the second function. As an example, Eqn. (1) may represent the first function and Eq. (2) may represent the second function with Eqn. (4) representing the combination of the first and second functions. In some embodiments, one or more layers of the neural network-based graph embedding model may process one or more user attributes based on the non-graph data, one or more layers of the neural network-based graph embedding model may process one or more user connections and/or relationships between the one or more users based on the graph data, and one or more layers of the neural network-based graph embedding model process the combination of the first function and the second function.

According to an embodiment, the generated numerical node representation of a first user among the one or more users and a second user among the one or more users have a cosine similarity higher than a threshold, and wherein the first user and the second user have a same classification label based on the classification. In the same or another embodiment, the generated numerical node representation of a first user among the one or more users and a second user among the one or more users have a cosine similarity higher than a threshold, and wherein the first user and the second user are in a same neighborhood based on the graph data.

The process 300 may also include the numerical node representation being input into a neural network-based classifier to generate classification results. In some embodiments, the neural network-based classifier may be trained using the classification data associated with the one or more users.

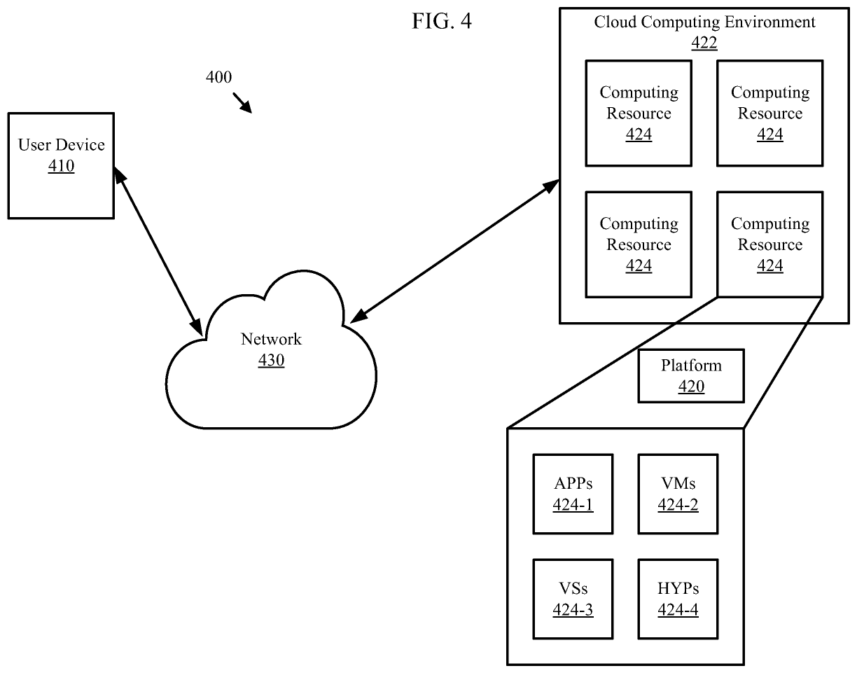

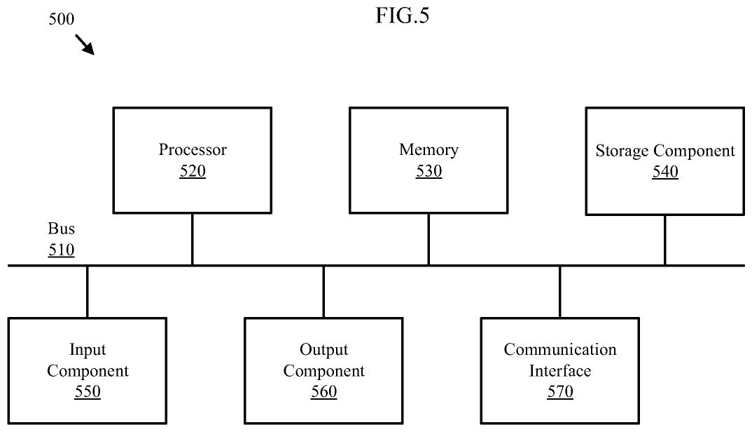

As shown in FIG. 3, one or more process blocks of processes 300 may be performed by any of the components of FIGS. 4 and 5 discussed in the present application. In FIG. 3, one or more process blocks of processes 300 may correspond to the operations associated with the user device 410.

FIG. 4 is a diagram of an example environment for implementing one or more operations, methods, systems, and/or frameworks of FIGS. 1-3.

As shown in FIG. 4, environment 400 may include a user device 410, a platform 420, and a network 430. Devices of environment 400 may interconnect via wired connections, wireless connections, or a combination of wired and wireless connections. In embodiments, any of the functions of the processes 100-300 may be performed by any combination of elements illustrated in FIG. 4.

The user device 410 may include one or more devices capable of receiving, generating, and storing, processing, and/or providing information associated with platform 420. For example, the user device 410 may include a computing device (e.g., a desktop computer, a laptop computer, a tablet computer, a handheld computer, a smart speaker, a server, etc.), a mobile phone (e.g., a smart phone, a radiotelephone, etc.), a camera device, a wearable device (e.g., a pair of smart glasses or a smart watch), or a similar device. In some implementations, the user device 410 may receive information from and/or transmit information to platform 420.

Platform 420 may include one or more devices capable of receiving, generating, storing, processing, and/or providing information. In some implementations, platform 420 may include a cloud server or a group of cloud servers. In some implementations, platform 420 may be designed to be modular such that certain software components may be swapped in or out depending on a particular need. As such, platform 420 may be easily and/or quickly reconfigured for different uses.

In some implementations, as shown, platform 420 may be hosted in cloud computing environment 422. Notably, while implementations described herein describe platform 420 as being hosted in cloud computing environment 422, in some implementations, platform 420 may not be cloud-based (i.e., may be implemented outside of a cloud computing environment) or may be partially cloud-based.

Cloud computing environment 422 includes an environment that hosts platform 420. Cloud computing environment 422 may provide computation, software, data access, storage, etc. services that do not require end-user (e.g., user device 410) knowledge of a physical location and configuration of system(s) and/or device(s) that hosts platform 420. As shown, cloud computing environment 422 may include a group of computing resources 424 (referred to collectively as “computing resources 424” and individually as “computing resource 424”).

Computing resource 424 includes one or more personal computers, a cluster of computing devices, workstation computers, server devices, or other types of computation and/or communication devices. In some implementations, computing resource 424 may host platform 420. The cloud resources may include compute instances executing in computing resource 424, storage devices provided in computing resource 424, data transfer devices provided by computing resource 424, etc. In some implementations, computing resource 424 may communicate with other computing resources 424 via wired connections, wireless connections, or a combination of wired and wireless connections.

As further shown in FIG. 4, computing resource 424 includes a group of cloud resources, such as one or more applications (“APPs”) 424-1, one or more virtual machines (“VMs”) 424-2, virtualized storage (“VSs”) 424-3, one or more hypervisors (“HYPs”) 424-4, or the like.

Application 424-1 includes one or more software applications that may be provided to or accessed by user device 410 or the network element 430 Application 424-1 may eliminate a need to install and execute the software applications on user device 410 or the network element 430. For example, application 424-1 may include software associated with platform 420 and/or any other software capable of being provided via cloud computing environment 422. In some implementations, one application 424-1 may send/receive information to/from one or more other applications 424-1, via virtual machine 424-2.

Virtual machine 424-2 includes a software implementation of a machine (e.g., a computer) that executes programs like a physical machine. Virtual machine 424-2 may be either a system virtual machine or a process virtual machine, depending upon use and degree of correspondence to any real machine by virtual machine 424-2. A system virtual machine may provide a complete system platform that supports execution of a complete operating system (“OS”). A process virtual machine may execute a single program, and may support a single process. In some implementations, virtual machine 424-2 may execute on behalf of a user (e.g., user device 410), and may manage infrastructure of cloud computing environment 422, such as data management, synchronization, or long-duration data transfers.

Virtualized storage 424-3 includes one or more storage systems and/or one or more devices that use virtualization techniques within the storage systems or devices of computing resource 424. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 424-4 may provide hardware virtualization techniques that allow multiple operating systems (e.g., “guest operating systems”) to execute concurrently on a host computer, such as computing resource 424. Hypervisor 424-4 may present a virtual operating platform to the guest operating systems, and may manage the execution of the guest operating systems. Multiple instances of a variety of operating systems may share virtualized hardware resources.

Network 430 includes one or more wired and/or wireless networks. For example, network 430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of one or more devices of FIGS. 1-4, according to embodiments of the present disclosure.

According to one embodiment, FIG. 5 may be diagram of example components of a user device 410. The user device 410 may correspond to a device associated with an authorized user, an operator of a cell, or a RF engineer. The user device 410 may be used to communicate with cloud platform 420 via the network element 430. As shown in FIG. 5, the user device 410 may include a bus 510, a processor 520, a memory 530, a storage component 540, an input component 550, an output component 560, and a communication interface 570.

Bus 510 may include a component that permits communication among the components of the user device 410. Processor 520 may be implemented in hardware, firmware, or a combination of hardware and software. Processor 520 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of the user device 410. For example, storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 550 includes a component that permits the user device 410 to receive information, such as via user input (e.g., a touch screen display, a keyboard, a keypad, a mouse, a button, a switch, and/or a microphone). Additionally, or alternatively, input component 550 may include a sensor for sensing information (e.g., a global positioning system (GPS) component, an accelerometer, a gyroscope, and/or an actuator). Output component 560 includes a component that provides output information from the user device 410 (e.g., a display, a speaker, and/or one or more light-emitting diodes (LEDs)).

Communication interface 570 includes a transceiver-like component (e.g., a transceiver and/or a separate receiver and transmitter) that enables the user device 410 to communicate with other devices, such as via a wired connection, a wireless connection, or a combination of wired and wireless connections. Communication interface 570 may permit the user device 410 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, or the like.

The user device 410 may perform one or more processes described herein. The user device 410 may perform these processes in response to processor 520 executing software instructions stored by a non-transitory computer-readable medium, such as memory 530 and/or storage component 540. A computer-readable medium may be defined herein as a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for graph embedding, the method being executed by at least one processor, the method comprising:
receiving graph data associated with one or more users;
receiving classification data associated with the one or more users, wherein the classification data comprises non-graph data associated with the one or more users;
generating an accuracy parameter based on the classification data associated with the one or more users, wherein the accuracy parameter indicates an accuracy of neural network-based classification results based on the classification data; and
generating numerical node representation using a neural network-based graph embedding model associated with the one or more users based on the graph data, the classification data, and the accuracy parameter.

2. The method of claim 1, wherein the method further comprises:
inputting the numerical node representation and a concatenation of node attributes into a neural network-based classifier, wherein the neural network-based classifier is trained using the classification data associated with the one or more users; and
generating classification results based on the neural network-based classifier.

3. The method of claim 1, wherein the neural network-based graph embedding model is based on a combination of a first function based on user relationships based on the graph data and a second function based on user classification labels based on the classification data.

4. The method of claim 1, wherein the numerical node representation of a first user among the one or more users and a second user among the one or more users have a cosine similarity higher than a threshold, and wherein the first user and the second user have a same classification label based on the classification data.

5. The method of claim 1, wherein the numerical node representation of a first user among the one or more users and a second user among the one or more users have a cosine similarity higher than a threshold, and wherein the first user and the second user are in a same neighborhood based on the graph data.

6. The method of claim 3, wherein generating the numerical node representation using the neural network-based graph embedding model comprises minimizing the combination of the first function and the second function.

7. The method of claim 3, wherein one or more second layers of the neural network-based graph embedding model process the combination of the first function and the second function.

8. The method of claim 1, wherein the accuracy parameter is based on a concatenation of one or more user attributes, wherein the one or more user attributes are based on the non-graph data.

9. The method of claim 1, wherein one or more first layers of the neural network-based graph embedding model process one or more user attributes based on the non-graph data.

10. An apparatus for graph embedding, the apparatus comprising:
at least one memory configured to store program code; and
at least one processor configured to read the program code and operate as instructed by the program code, the program code comprising:
first receiving code configured to cause the at least one processor to receive graph data associated with one or more users;
second receiving code configured to cause the at least one processor to receive classification data associated with the one or more users, wherein the classification data comprises non-graph data associated with the one or more users;
first generating code configured to cause the at least one processor to generate an accuracy parameter based on the classification data associated with the one or more users, wherein the accuracy parameter indicates an accuracy of neural network-based classification results based on the classification data; and
second generating code configured to cause the at least one processor to generate numerical node representation using a neural network-based graph embedding model associated with the one or more users based on the graph data, the classification data, and the accuracy parameter.

11. The apparatus of claim 10, wherein the program code further comprises:
inputting code configured to cause the at least one processor to input the numerical node representation and a concatenation of node attributes into a neural network-based classifier, wherein the neural network-based classifier is trained using the classification data associated with the one or more users; and
third generating code configured to cause the at least one processor to generate classification results based on the neural network-based classifier.

12. The apparatus of claim 10, wherein the neural network-based graph embedding model is based on a combination of a first function based on user relationships based on the graph data and a second function based on user classification labels based on the classification data.

13. The apparatus of claim 10, wherein the numerical node representation of a first user among the one or more users and a second user among the one or more users have a cosine similarity higher than a threshold, and wherein the first user and the second user have a same classification label based on the classification data.

14. The apparatus of claim 10, wherein the numerical node representation of a first user among the one or more users and a second user among the one or more users have a cosine similarity higher than a threshold, and wherein the first user and the second user are in a same neighborhood based on the graph data.

15. The apparatus of claim 12, wherein generating the numerical node representation using the neural network-based graph embedding model comprises minimizing the combination of the first function and the second function.

16. The apparatus of claim 12, wherein one or more second layers of the neural network-based graph embedding model process the combination of the first function and the second function.

17. The apparatus of claim 10, wherein the accuracy parameter is based on a concatenation of one or more user attributes, wherein the one or more user attributes are based on the non-graph data.

18. A non-transitory computer-readable medium storing instructions for graph embedding, the instructions comprising: one or more instructions that, when executed by one or more processors, cause the one or more processors to:
receive graph data associated with one or more users;
receive classification data associated with the one or more users, wherein the classification data comprises non-graph data associated with the one or more users;
generate an accuracy parameter based on the classification data associated with the one or more users, wherein the accuracy parameter indicates an accuracy of neural network-based classification results based on the classification data; and
generate numerical node representation using a neural network-based graph embedding model associated with the one or more users based on the graph data, the classification data, and the accuracy parameter.

19. The non-transitory computer-readable medium of claim 18, wherein the neural network-based graph embedding model is based on a combination of a first function based on user relationships based on the graph data and a second function based on user classification labels based on the classification data.

20. The non-transitory computer-readable medium of claim 19, wherein generating the numerical node representation using the neural network-based graph embedding model comprises minimizing the combination of the first function and the second function.
